(19) United States
(12) Patent Application Publication
(10) Pub. No.: US 2014/0161688 A1
(43) Pub. Date: Jun. 12, 2014

(54) APPARATUS, SYSTEM, AND METHOD FOR COLLECTING A TARGET MATERIAL

(71) Applicant: RareCyte, Inc., Seattle, WA (US)

(72) Inventors: Daniel Campton, Seattle, WA (US); Joshua Nordberg, Bainbridge Island, WA (US); Steve Quarre, Woodinville, WA (US); David Stewart, Seattle, WA (US); Ronald Seubert, Sammamish, WA (US); Jonathan Erik Lundt, Seattle, WA (US)

(73) Assignee: RareCyte, Inc., Seattle, WA (US)

(21) Appl. No.: 14/090,337

(22) Filed: Nov. 26, 2013

Related U.S. Application Data
(60) Provisional application No. 61/732,029, filed on Nov. 30, 2012.
(60) Provisional application No. 61/745,094, filed on Dec. 21, 2012.
(60) Provisional application No. 61/791,883, filed on Mar. 15, 2013.
(60) Provisional application No. 61/818,301, filed on May 1, 2013.
(60) Provisional application No. 61/869,866, filed on Aug. 26, 2013.

(51) Int. Cl. B01L 3/00; B01D 21/26

(52) U.S. Cl. CPC B01L 3/5082; B01D 21/26
USPC 422/533; 422/547; 422/549

(57) ABSTRACT

This disclosure is directed to an apparatus, system and method for retrieving a target material from a suspension. A system includes a processing vessel, such as an Eppendorf tube, a syringe or a test tube, and a collector. The collector is sized and shaped to fit into a primary vessel, such as a test tube. The collector funnels the target material from the suspension through a cannula and into the processing vessel. The collector includes a funnel at a second end in fluid communication with the cannula. The cannula extends into a chamber at a first end of the collector that holds the processing vessel. In one implementation, the processing vessel is empty. In another implementation, the processing vessel includes at least one displacement fluid. In yet another implementation, the processing vessel may include at least one displacement fluid and at least one processing solution. The collector may also expel at least one displacement fluid from the processing vessel, such that the at least one displacement fluid pushes the target material into the collector.

### CROSS-REFERENCE TO A RELATED APPLICATION

This application claims the benefit of Provisional Application No. 61/732,029, filed Nov. 30, 2012; Provisional Application No. 61/745,094, filed Dec. 21, 2012; Provisional Application No. 61/791,883, filed Mar. 15, 2013; Provisional Application No. 61/818,301, filed May 1, 2013; and Provisional Application No. 61/869,866, filed Aug. 26, 2013.

### TECHNICAL FIELD

This disclosure relates generally to density-based fluid separation and, in particular, to retrieving a target material from a suspension.

### BACKGROUND

Suspensions often include materials of interests that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as ova, fetal cells, endothelial cells, parasites, bacteria, and inflammatory cells, and viruses, including HIV, cytomegalovirus, hepatitis C virus, and Epstein-Barr virus. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest that occur in a suspension with very low concentrations are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers. However, CTCs occur in very low numbers in peripheral whole blood samples. For instance, a 7.5 ml sample of peripheral whole blood sample that contains as few as 5 CTCs is considered clinically relevant for the diagnosis and treatment of a cancer patient. In other words, detecting 5 CTCs in a 7.5 ml blood sample is equivalent to detecting 1 CTC in a background of about 10 billion red and white blood cells, which is extremely time consuming, costly and difficult to accomplish using blood film analysis.

As a result, practitioners, researchers, and those working with suspensions continue to seek systems and methods for accurate analysis of suspensions for the presence or absence rare materials of interest.

### DESCRIPTION OF THE DRAWINGS

FIGS. 1A-1B an example collector.

FIGS. 1C-1D an example collector.

FIG. 2A-2C show an example collector and processing vessel system.

FIGS. 3A-3B show an example sealing ring.

FIG. 3C-3D show an example sealing ring.

FIGS. 3E-3F show an example sealing ring.

FIG. 3G shows an example sealing ring.

FIG. 4 shows a flow diagram of an example method for retrieving a target material.

FIGS. 5A-5B show example float and primary vessel systems.

FIG. 6 shows an example float and primary vessel system having undergone density-based separation.

FIG. 7A shows an example clamp with an example sealing ring and an example tube and float system.

FIG. 7B shows the example sealing ring and the example float and primary vessel system of FIG. 7A forming a seal.

FIGS. 8A-8B show an example system retrieving a target material.

### DETAILED DESCRIPTION

This disclosure is directed to an apparatus, system and method for retrieving a target material from a suspension. A system includes a processing vessel, such as an Eppendorf tube, a syringe or a test tube, and a collector. The collector is sized and shaped to fit into a primary vessel, such as a test tube. The collector funnels the target material from the suspension through a cannula and into the processing vessel. The collector includes a funnel at a second end in fluid communication with the cannula. The cannula extends into a chamber at a first end of the collector that holds the processing vessel. In one implementation, the processing vessel is empty. In another implementation, the processing vessel includes at least one displacement fluid. In yet another implementation, the processing vessel may include at least one displacement fluid and at least one processing solution. The collector may also expel at least one displacement fluid from the processing vessel, such that the at least one displacement fluid pushes the target material into the collector.

### Collector

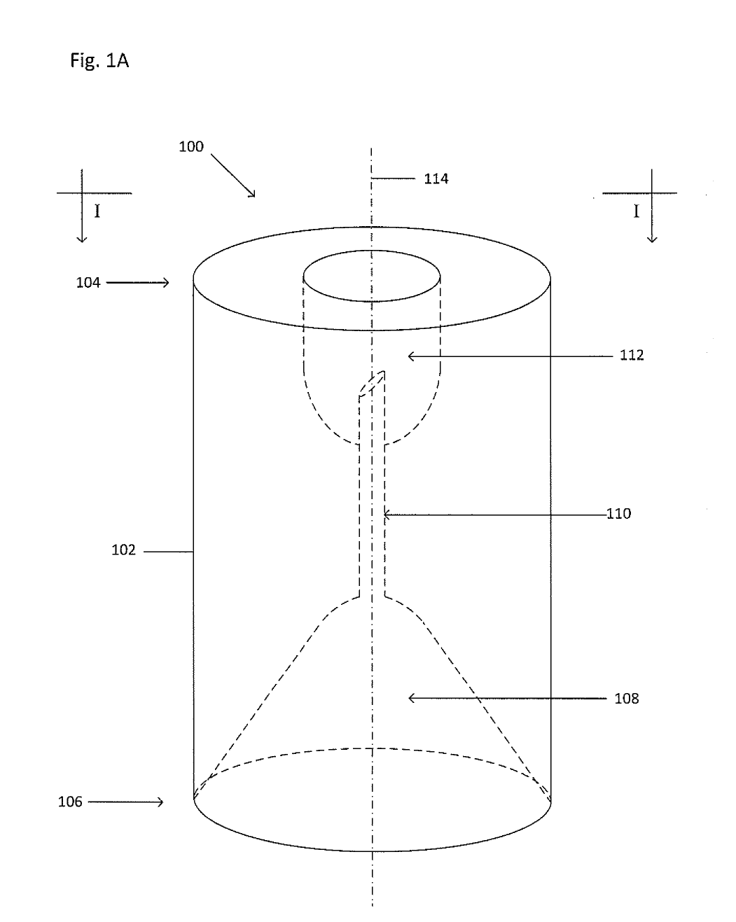

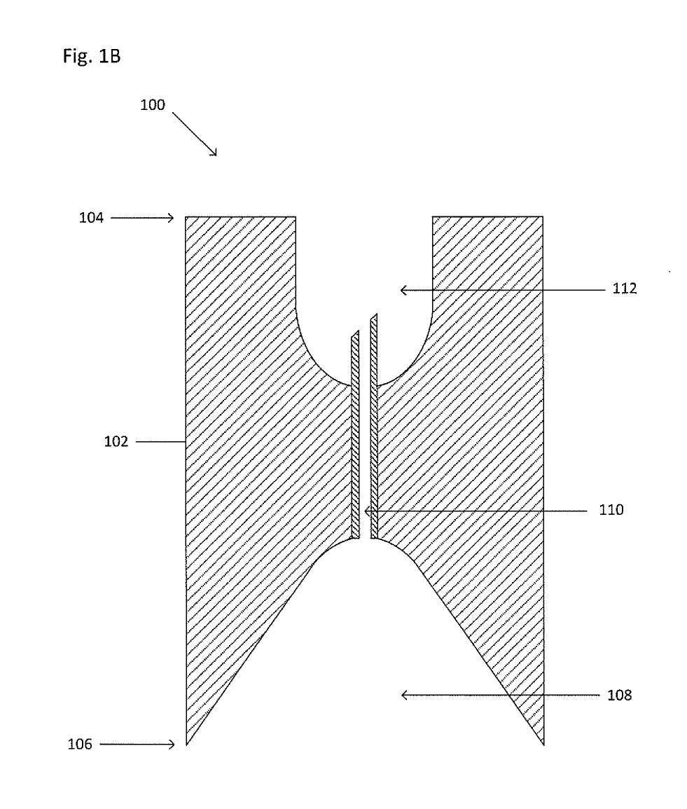

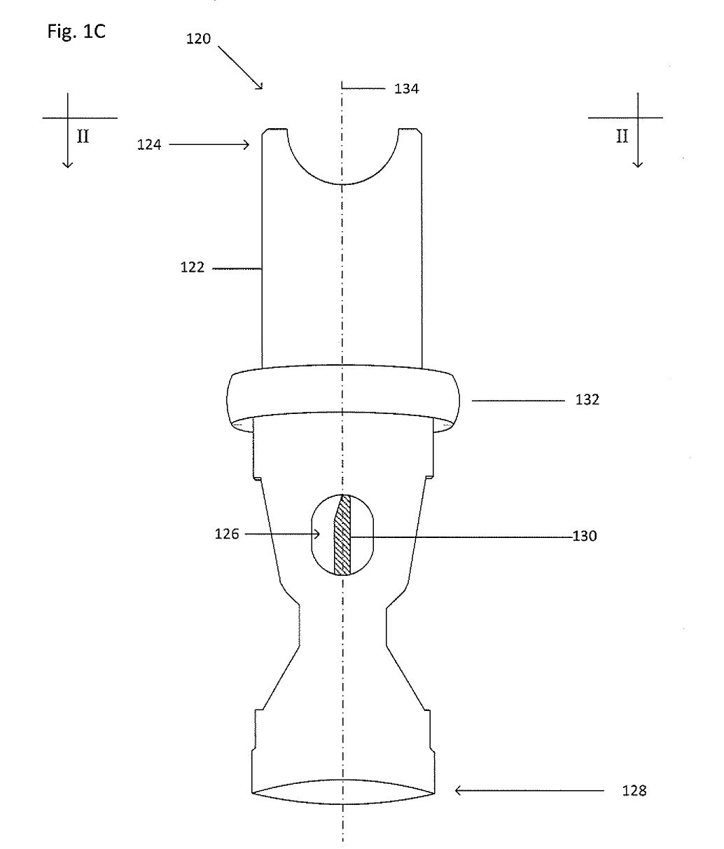

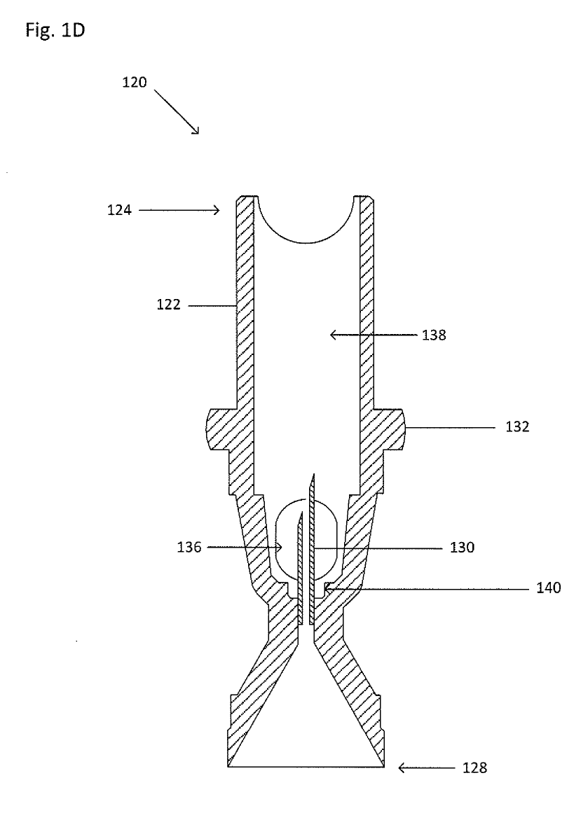

FIG. 1A shows an isometric view of a collector 100. FIG. 1B shows a cross-section view of the collector 100 taken along the line I-I. Dot-dashed line 114 represents the central or highest-symmetry axis of the collector 100. The collector 100 may be sized and shaped to fit within a primary vessel containing or capable of holding a suspension, the suspension suspected of including a target material. The collector 100 may engage in an interference or sealed fit with an inner wall of the primary vessel to inhibit any portion of the suspension from being located between the inner wall of the vessel and the outer wall 110 of the collector 100. The collector 100 funnels the target material from the suspension through a cannula 110 and into a processing vessel (not shown) located within a chamber 112.

The collector 100 includes a primary body 102. The primary body 102 includes a first end 104 and a second end 106. The primary body 102 may be any appropriate shape, including, but not limited to, cylindrical, triangular, square, rectangular, or the like. The collector 100 also includes a funnel 108 which is a concave cavity extending from the second end 106 into the primary body 102. The funnel 108 channels a target material from below the second end 106 into a cannula 110 which is connected to and in fluid communication with a apex of the funnel 108. The apex of the funnel 108 has a smaller diameter than the mouth of the funnel 108. The funnel 108 is formed by a tapered wall that may be straight, curvilinear, arcuate, or the like.

The cannula 110, such as a tube or a needle, including, but not limited to a non-coring needle, extends from the apex of the funnel 108 and into the chamber 112. The chamber 112 is a cavity to accept and support the processing vessel (not shown). The chamber 112 may be threaded to engage a threaded portion of the processing vessel (not shown). The cannula 110 may extend any appropriate distance into the chamber 112 in order to puncture or be inserted into the processing vessel (not shown). The cannula 112 may include a flat tip or a tapered tip. The chamber 112 is a concave cavity extending from the first end 104 into the primary body 102. The chamber 112 may be any appropriate depth to accept and support the processing vessel (not shown). Furthermore, the chamber 112 may be any appropriate shape, including, but not limited to, semi-spherical, conical, pyramidal, or the like.

The collector 100 may also include a retainer (not shown) to prevent the collector 100 from sliding relative to the primary vessel, thereby keeping the collector 100 at a pre-determined height within the primary vessel. The retainer (not shown) may be a shoulder extending radially from the first end 104, a clip, a circular protrusion that extends beyond the circumference of the cylindrical primary body 102, a detent, or the like.

FIG. 1C shows an isometric view of a collector 120. FIG. 1D shows a cross-section view of the collector 120 taken along the line II-II. Dot-dashed line 134 represents the central or highest-symmetry axis of the collector 120. The collector 120 is similar to the collector 100, except that the collector 120 includes a window 126, a ridge 132, and a primary body 122 to accommodate a greater portion of the processing vessel (not shown). In the collector 100 shown in FIGS. 1A-1B with collector 120 shown in FIGS. 1C-1D, the primary body 122 is longer than the primary body 102. The window 126 permits an operator to confirm proper placement and chambering of the processing vessel (not shown) within the collector 120. The collector 120 includes a cavity 138 dimensioned to accept and hold at least a portion of the processing vessel (not shown). The cavity 138 may have a tapered or stepped bottom end 140 to act as a chamber on which the processing vessel (not shown) may rest. The first end 124 may include cut-outs to permit proper grip of the processing vessel (not shown) for insertion and removal. A second end 128 forms an interference or sealed fit with the primary vessel to prevent fluid from flowing around the collector 120. The collector 120 also includes a ridge 132, which extends circumferentially around the primary body 122. The ridge 132 may be larger than the inner diameter of the primary vessel so as to rest on the open end of the primary vessel and, upon applying a lock ring (not shown) to the outside of the primary vessel and the ridge 132, to inhibit movement of the collector 120 relative to the primary vessel. The lock ring (not shown) applies pressure to the primary vessel along the ridge 132. The lock ring may be a two-piece ring, a one piece ring wrapping around the full circumference of the primary vessel, or a one piece ring wrapping around less than the full circumference of the primary vessel, such as one-half (½), five-eighths (⅝), two-thirds (⅔), three-quarters (¾), seven-eighths (⅞), or the like. Alternatively, the ridge 132 may fit within the primary vessel.

The primary body can be composed of a variety of different materials including, but not limited to, a ceramic; metals; organic or inorganic materials; and plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer, butyl rubber, ethylene propylene diene monomer; and combinations thereof.

The cannula can be composed of a variety of different materials including, but not limited to, a ceramic; metals; organic or inorganic materials; and plastic materials, such as a polypropylene, acrylic, polycarbonate, or the like; and combinations thereof. The cannula may have a tip along a longitudinal axis of the cannula.

### Collector and Processing Vessel System

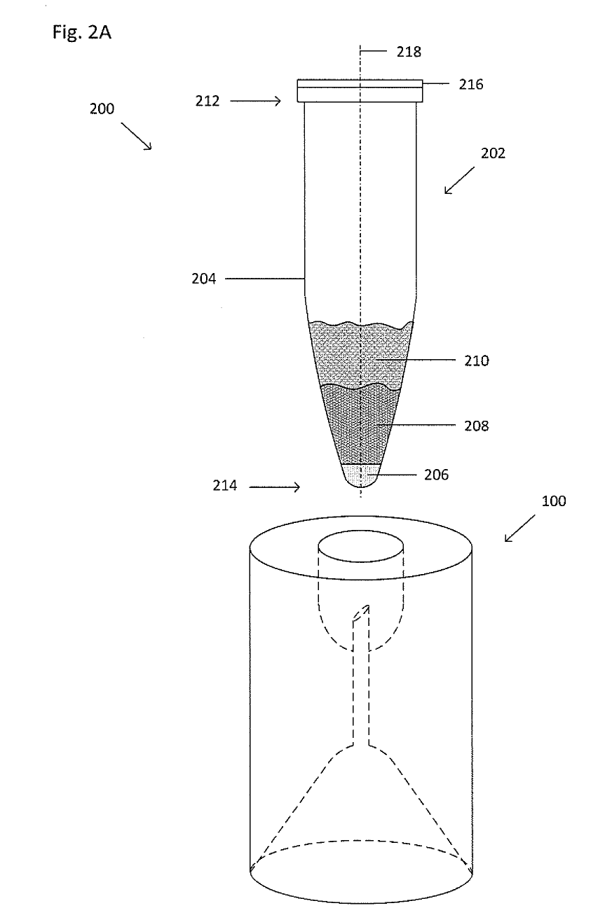

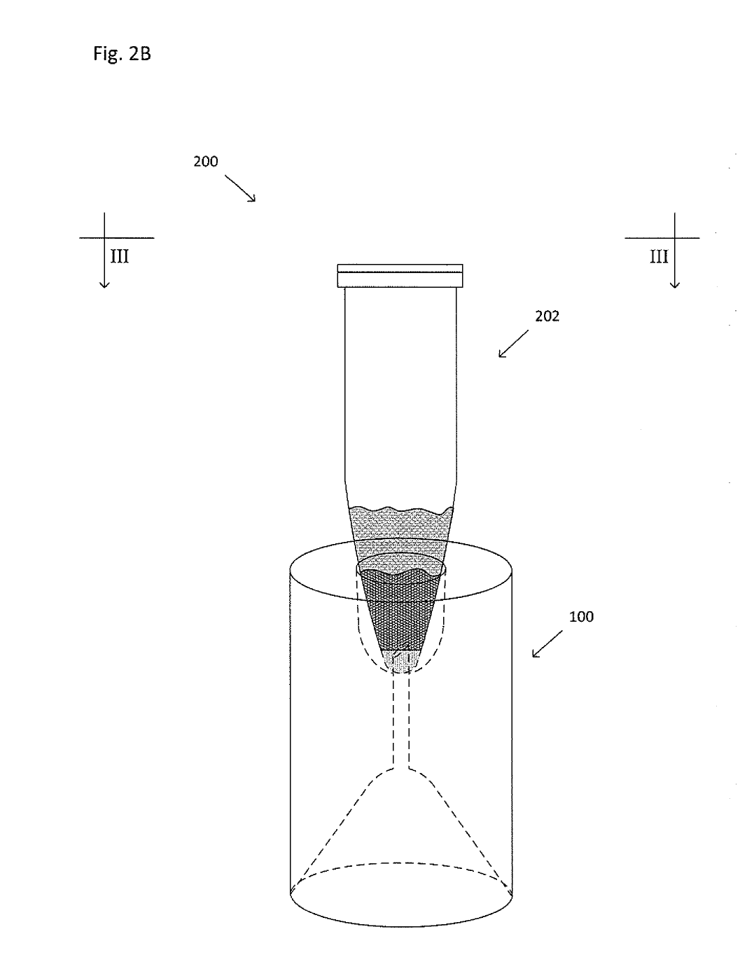

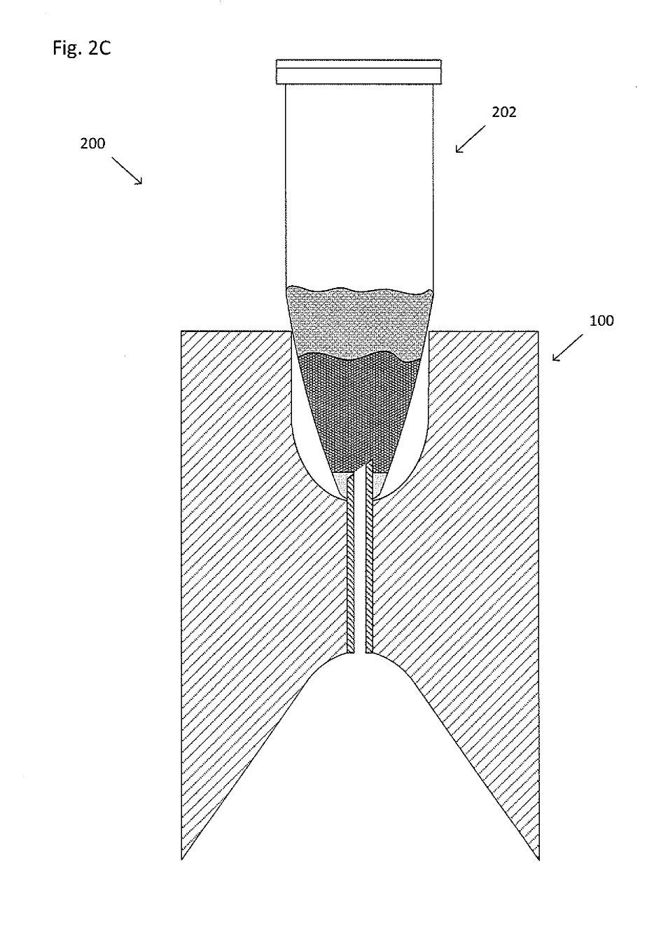

FIG. 2A shows an exploded view of the example collector 100 and processing vessel 202. FIG. 2B shows an isometric view of the example processing vessel inserted into the chamber 112 of the collector 100. FIG. 2C shows a cross-sectional view of the processing vessel inserted into the chamber 112 of the collector 100 and processing vessel system 202 taken along the line III-III. The collector 100 and processing vessel 202 form a collector and processing vessel system 200. The processing vessel 202 may be an Eppendorf tube, a syringe, or a test tube and has a closed end 214 and an open end 212. The open end 212 is sized to receive a cap 216. The cap 216 may be composed of re-sealable rubber or other suitable re-sealable material that can be repeatedly punctured with a needle or other sharp implement to access the contents stored in the processing vessel 202 interior and re-seals when the needle or implement is removed. Alternatively, the processing vessel 202 may also have two open ends that are sized to receive caps. The processing vessel 202 may have a tapered geometry that widens or narrows toward the open end 212; the processing vessel 202 may have a generally cylindrical geometry; or, the processing vessel 202 may have a generally cylindrical geometry in a first segment and a cone-shaped geometry in a second segment, where the first and second segments are connected and continuous with each other. Although at least one segment of the processing vessel 202 has a circular cross-section, in other embodiments, the at least one segment can have elliptical, square, triangular, rectangular, octagonal, or any other suitable cross-sectional shape. The processing vessel 202 can be composed of a transparent, semitransparent, opaque, or translucent material, such as plastic or another suitable material. The processing vessel includes a central axis 218. The processing vessel 202 may also include a plug 206 at the closed end 214 to permit the introduction of the target material or to exchange the target material with a displacement fluid. The closed end 214 may be threaded to provide for a threaded connection with a threaded chamber 112 of the collector 100. The processing vessel 202 may be composed of glass, plastic, or other suitable material.

The plug 206 may be composed of re-sealable rubber or other suitable re-sealable material that can be repeatedly punctured with a needle or other sharp implement to access the contents of the processing vessel 202 interior or permit introduction of contents into the processing vessel 202 and re-seals when the needle or implement is removed. The plug 206 can be formed in the closed end 214 of the processing vessel 202 using heated liquid rubber that can be shaped and hardens as the rubber cools. The adhesive used to attach a plug to the wall can be a polymer-based adhesive, an epoxy, a contact adhesive or any other suitable material for bonding or creating a thermal bond. Alternatively, the plug 206 may be injected into the processing vessel 202.

When the cannula 112 includes a tapered tip, a portion of the tapered tip may extend into an inner cavity of the processing vessel 202, whereas another portion of the tapered tip does not enter the inner cavity of the processing vessel 202. The inner cavity of the processing vessel 202 is the portion of the processing vessel 202 to hold the suspension. The cannula 110 may be covered by a resealable sleeve (not shown) to prevent the target material from flowing out unless the processing vessel 202 is in the chamber 112 and is inserted to a depth appropriate enough for the cannula 112 to penetrate the processing vessel 202. The resealable sleeve (not shown) covers the cannula 110, is spring-resilient, can be penetrated by the cannula 110, and is made of an elastomeric material capable of withstanding repeated punctures while still maintaining a seal.

The processing vessel 202 may be loaded with a displacement fluid 208 prior to introduction to the collector 100. The displacement fluid 208 displaces the target material, such that when the collector 100 and processing vessel 200 are inserted into a primary vessel (not shown) including the target material and the collector, processing vessel, and primary vessel undergo centrifugation, the displacement fluid 208 flows out of the processing vessel 202 and into the primary vessel, and, through displacement, pushes the target material into the funnel 108, through the cannula 110, and into the processing vessel 202.

The displacement fluid 208 has a greater density than the density of the target material of the suspension (the density may be less than the density of at least one other suspension fraction or the density may be greater than all of the suspension fractions) and is inert with respect to the suspension materials. The displacement fluid 208 may be miscible or immiscible in the suspension fluid. Examples of suitable displacement fluids include, but are not limited to, Percoll, Ficoll, an organic solvent, a liquid wax, an oil, a gas, and combinations thereof; olive oil, mineral oil, silicone oil, chill-out liquid wax, paraffin wax, microcrystalline waxes, soy and palm waxes, candle waxes, thermoset waxes, hot melt adhesives, atactic polypropylene and polyolefin compounds, petroleum waxes, dental waxes, animal waxes, vegetable waxes, mineral waxes, petroleum waxes, and synthetic waxes, such as ethylenic polymers, chlorinated naphthalenes or hydrocarbon-type waxes; immersion oil, mineral oil, paraffin oil, silicon oil, fluorosilicone, perfluorodecalin, perfluoroperhydrophenanthrene, perfluorooctylbromide, and combinations thereof; organic solvents such as 1,4-Dioxane, acetonitrile, ethyl acetate, tert-butanol, cyclohexanone, methylene chloride, tert-Amyl alcohol, tert-Butyl methyl ether, butyl acetate, hexanol, nitrobenzene, toluene, octanol, octane, propylene carbonate, tetramethylene sulfones, and ionic liquids; perfluoroketones, such as perfluorocyclopentanone and perfluorocyclohexanone, fluorinated ketones, hydrofluoroethers, hydrofluorocarbons, perfluorocarbons, perfluoropolyethers, silicon and silicon-based liquids, such as phenylmethyl siloxane.

The density of the displacement fluid 208 may be static (remaining constant) or dynamic (changing in response to certain conditions). These conditions include, but are not limited to, pressure and temperature.

The processing vessel 202 may also include a processing solution 210 to effect a transformation on the target material when the target material enters the processing vessel 202. The processing solution 210 may be a preservative, a cell adhesion solution, a dye, or the like. Unlike the displacement fluid 208, most, if not all, of the processing solution 210 remains within the processing vessel 202 upon centrifugation, thereby effecting the transformation on the target material in one manner or another (i.e. preserving, increasing adhesion properties, or the like). The processing solution 210 may be introduced as a liquid or as a liquid container in a casing. The casing may be dissolvable in an aqueous solution but not in the displacement fluid 208 (such as gel cap); or, the casing may be breakable, such that the casing breaks when the processing vessel 210 is shaken in a vortex mixer. Additionally, more than one processing solution may be used.

The processing vessel 202 may include a flexible cap that can be pushed to dispense a pre-determined volume therefrom and onto the substrate. The cap 216 may be flexible or the cap 216 may be removed and the flexible cap inserted into the open end 212. Alternatively, the processing vessel 202 may be attached to (i.e. after accumulating the target material) or may include a dispenser, which is capable of dispensing a pre-determined volume of target material from the processing vessel 202 onto another substrate, such as a microscope slide. The dispenser may repeatedly puncture the re-sealable cap 216 or compress the material within the processing vessel 202 to withdraw and dispense the pre-determined volume of target material onto the substrate. Alternatively, the cap 216 may be removed and the dispenser (not shown) may be inserted directly into the processing vessel 202 to dispense the Buffy coat-processing solution mixture.

### Sealing Ring

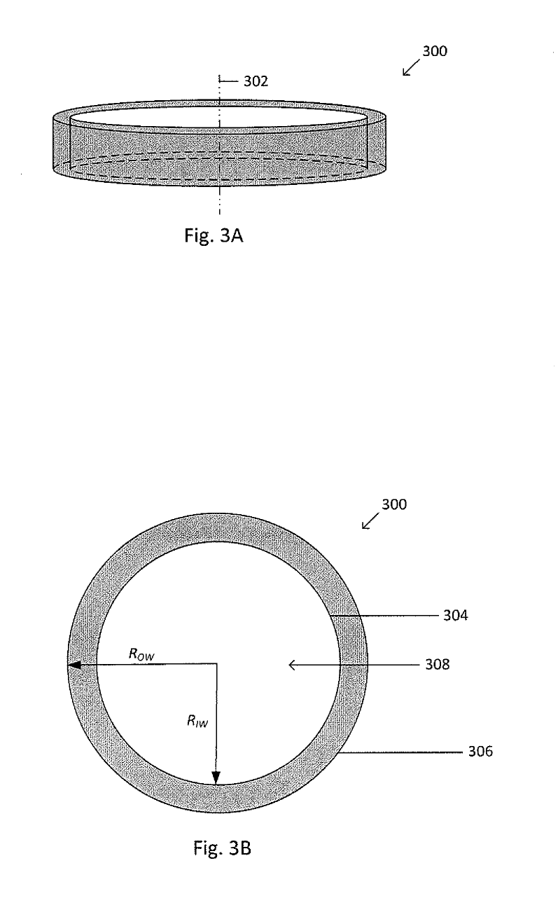

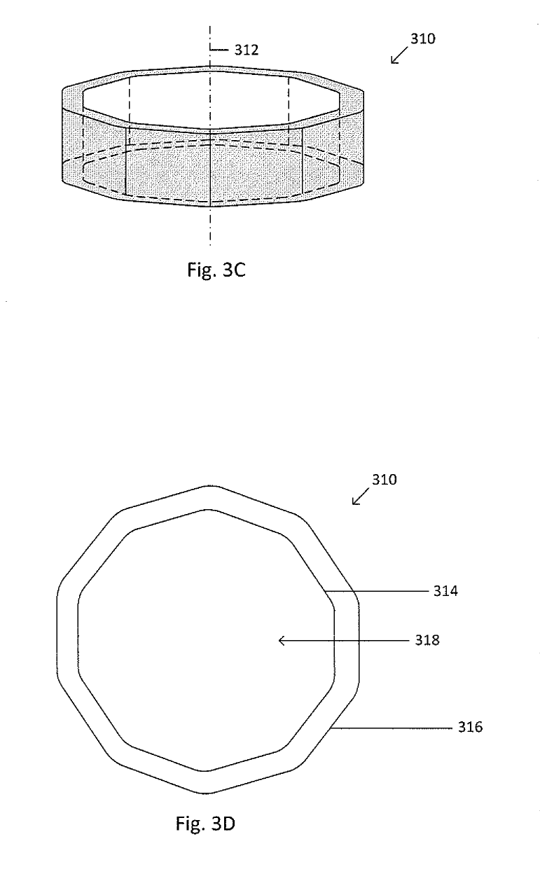

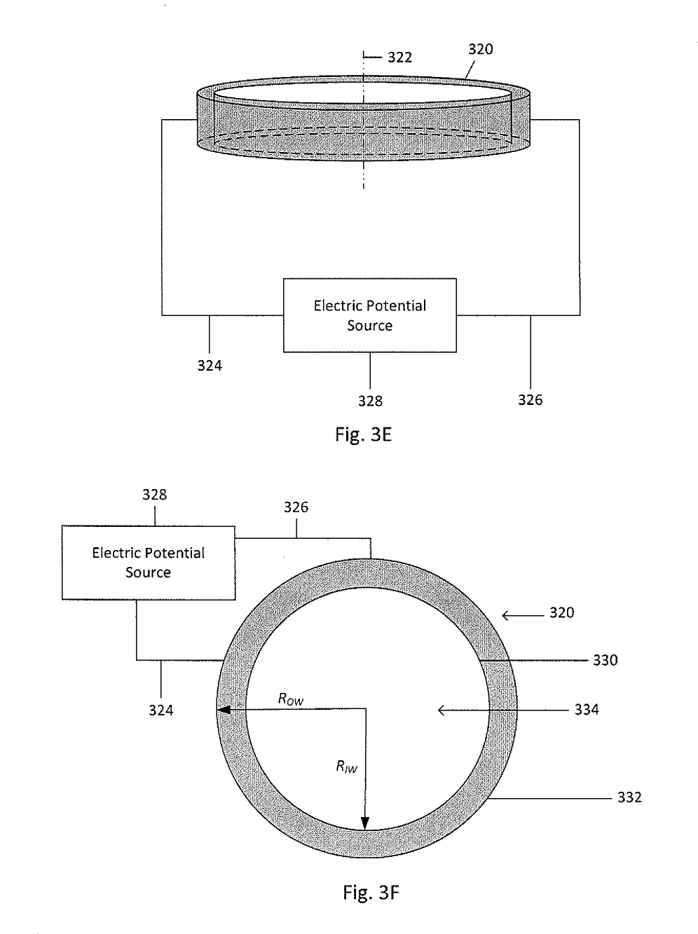

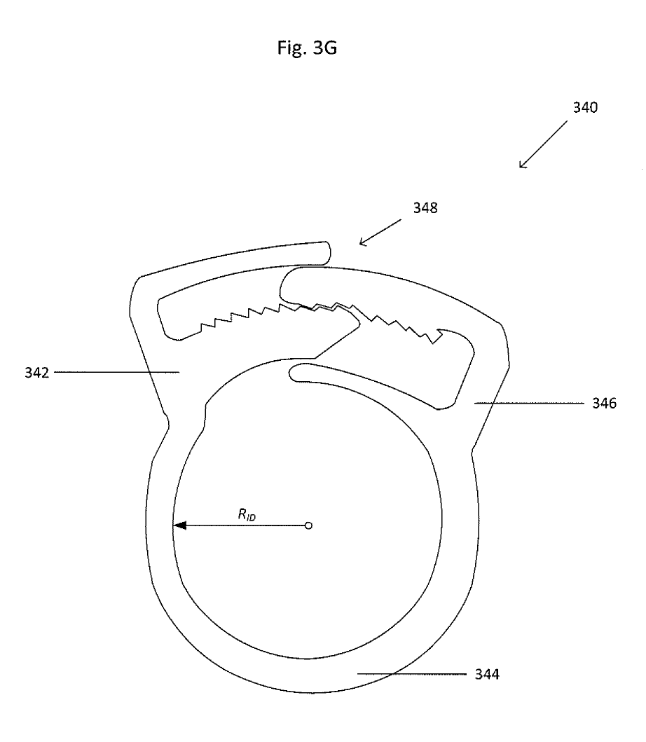

FIG. 3A shows an isometric view of a sealing ring 300. FIG. 3B shows a top down view of the sealing ring 300. Dot-dashed line 302 represents the central or highest-symmetry axis of the sealing ring 300. The sealing ring 300 includes an inner wall 304, an outer wall 306, and a cavity 308. In FIG. 3B, R_{IW} represents the radial distance from the center of the sealing ring 300 to the inner wall 304, and R_{OW} represents the radial distance from the center of the sealing ring 300 to the outer wall 306. The sealing ring 300 is configured to fit around a vessel, such as a tube. The cavity 308 is sized and shaped to receive the vessel. The sealing ring 300 may be tightened, such that the size of the cavity 308 and the radii of the inner and outer walls 304 and 306 are reduced by circumferentially applying an approximately uniform, radial force, such as the radial force created by a clamp, around the outer wall 306 directed to the central axis 302 of the sealing ring 300. When the sealing ring 300 is tightened around the vessel, the uniform force applied to the sealing ring 300 is applied to the vessel, thereby causing the vessel to constrict. When the radial force is removed from the sealing ring 300, the sealing ring 300 remains tightened and in tension around the vessel, thereby causing the vessel to remain in the constricted state.

The sealing ring may be any shape, including, but not limited to, circular, triangular, or polyhedral. FIG. 3C shows an isometric view of a sealing ring 310. FIG. 3D shows a top down view of the sealing ring 310. Sealing ring 310 is similar to sealing ring 300, except sealing ring 310 is polyhedral. Dot-dashed line 312 represents the central or highest-symmetry axis of the sealing ring 310. The sealing ring 310 includes an inner wall 314, an outer wall 316, and a cavity 318. The sealing ring may be composed of a metal, such as brass, a polymer, or combinations thereof.

Alternatively, as shown in FIG. 3E, a sealing ring 320 may be composed of a piezoelectric material. Dot-dashed line 322 represents the central or highest-symmetry axis of the sealing ring 320. The sealing ring 320 may be connected to an electric potential source 328, such as a battery, via a first lead 324 and a second lead 326. The electric potential source 328 creates an electric potential that when applied to the sealing ring 320 produces a mechanical strain that causes the sealing ring 320 to tighten (i.e. sealing ring 320 tightens when an electric potential is applied). FIG. 3F shows a top down view of the sealing ring 320. The sealing ring 320 includes an inner wall 330, an outer wall 332, and a cavity 334. In FIG. 3F, R_{IW} represents the radial distance from the center of the sealing ring 320 to the inner wall 330, and R_{OW} represents the radial distance from the center of the sealing ring 320 to the outer wall 332. When the sealing ring 320 is composed on the piezoelectric material, a clamp is not required, because the mechanical strain causes the sealing ring 320 to tighten without applying an external force, except for the requisite electric potential. Alternatively, the sealing ring 320 may be in a naturally tightened stated. When applying the electric potential the sealing ring 320 expands. Alternatively, a portion of the sealing ring may be composed of the piezoelectric material, such that the piezoelectric portion acts as an actuator to cause the other portion of the sealing ring to tighten and apply the substantially uniform circumferential pressure on the tube, thereby constricting the tube to form the seal.

FIG. 3G shows an isometric view of a sealing ring 340. The sealing ring includes an adjustment mechanism 348 to adjust the inner diameter R_{ID}. The collapsible ring includes a first end 342 and a second end 346, the first and second ends 342 and 346 being joined by a band portion 344. The first and second ends 342 and 346 include complementary portions of the adjustment mechanism 348. The adjustment mechanism 348 includes, but is not limited to, a ratchet, tongue and groove, detents, or the like.

The sealing ring may also include a thermal element, such as a heated wire. The thermal element may soften the vessel for constriction. Alternatively, the thermal element may melt the vessel to provide a more adherent seal. Alternatively, the thermal element may cause the sealing ring to compress, thereby forming a seal between the tube and float.

### Method

For the sake of convenience, the methods are described with reference to an example suspension of anticoagulated whole blood. But the methods described below are not intended to be so limited in their scope of application. The methods, in practice, can be used with any kind of suspension. For example, a sample suspension can be urine, blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. It should also be understood that a target material can be a fraction of a sample suspension, such as Buffy coat, a cell, such as ova, a fetal nucleated red blood cell, or a circulating tumor cell (“CTC”), a circulating endothelial cell, a fetal cell, a vesicle, a liposome, a protein, a nucleic acid, a biological molecule, a naturally occurring or artificially prepared microscopic unit having an enclosed membrane, parasites, microorganisms, viruses, or inflammatory cells.

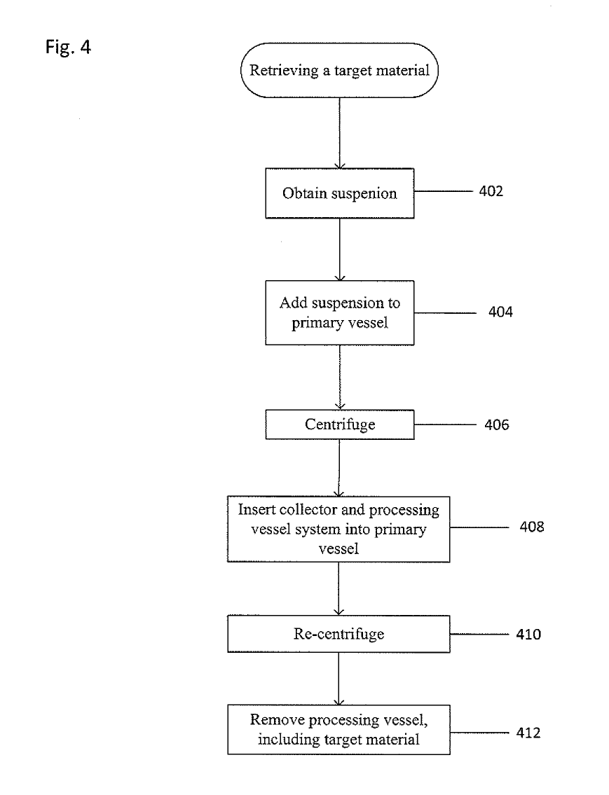

FIG. 4 shows a flow diagram for an example method for retrieving a target material. In block 402, a suspension, such as anticoagulated whole blood, is obtained. In block 404, the whole blood is added to a primary vessel, such as a test tube. A float may also be added to the primary vessel. A seal may be formed between the float and the primary vessel. For the sake of convenience, the methods are described with reference to the float and the seal. But the methods described below are not intended to be so limited in their application and may be performed without the float and/or the seal.

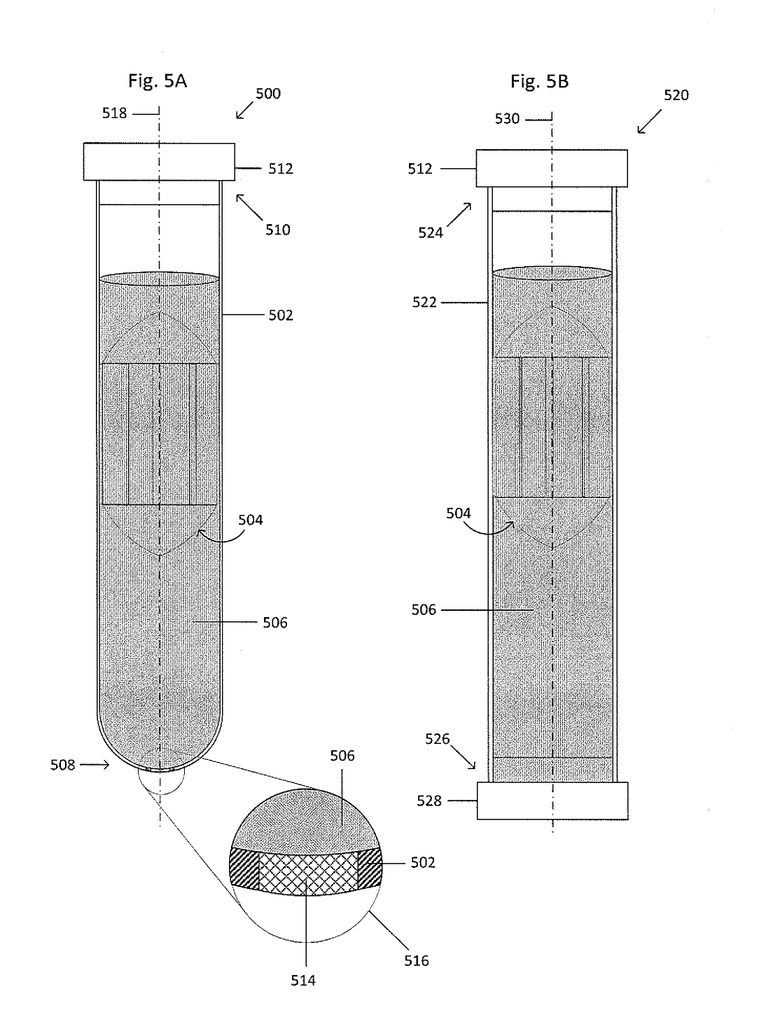

FIG. 5A shows an isometric view of an example primary vessel and float system 500. The system 500 includes a primary vessel 502 and a float 504 suspended within whole blood 506. In the example of FIG. 5A, the primary vessel 502 has a circular cross-section, a first closed end 510, and a second open end 508. The open end 508 is sized to receive a cap 512. The primary vessel may also have two open ends that are sized to receive caps, such as the example tube and separable float system 520 shown FIG. 5B. The system 520 is similar to the system 500 except the primary vessel 502 is replaced by a primary vessel 522 that includes two open ends 524 and 526 configured to receive the cap 512 and a cap 528, respectively. The primary vessels 502 and 522 have a generally cylindrical geometry, but may also have a tapered geometry that widens, narrows, or a combination thereof toward the open ends 510 and 524, respectively. Although the primary vessels 502 and 522 have a circular cross-section, in other embodiments, the primary vessels 502 and 522 can have elliptical, square, triangular, rectangular, octagonal, or any other suitable cross-sectional shape that substantially extends the length of the tube. The primary vessels 502 and 522 can be composed of a transparent, semitransparent, opaque, or translucent material, such as plastic or another suitable material. The primary vessels 502 and 522 each include a central axis 518 and 530, respectively. The primary vessel 502 may also include a septum 514, as seen in magnified view 516, at the closed end 508 to permit the removal of a fluid, the suspension, or a suspension fraction, whether with a syringe, a pump, by draining, or the like. The primary vessel 502 may have a sidewall and a first diameter.

The septum 514 may be composed of re-sealable rubber or other suitable re-sealable material that can be repeatedly punctured with a needle or other sharp implement to access the contents of the primary vessel 502 interior and re-seals when the needle or implement is removed. The septum 514 can be formed in the openings and/or the bottom interior of the tube using heated liquid rubber that can be shaped and hardens as the rubber cools. The adhesive used to attach the septum 514 to the wall of the opening and tube interior and can be a polymer-based adhesive, an epoxy, a contact adhesive or any other suitable material for bonding rubber to plastic or creating a thermal bond.

FIGS. 5A-5B show the float 504. The float 504 includes a main body, two teardrop-shaped end caps, and support members radially spaced and axially oriented on the main body. The float 504 can also include two dome-shaped end caps or two cone-shaped end caps or any appropriately-shaped end cap. The support members may engage the inner wall of the primary vessel 502. Alternatively, the float 504 may not include any support members. Alternatively, the float 504 may include support members which do not engage the inner wall of the primary vessel 502.

In alternative embodiments, the number of support members, support member spacing, and support member thickness can each be independently varied. The support members can also be broken or segmented. The main body is sized to have an outer diameter that is less than the inner diameter of the primary vessel 502, thereby defining fluid retention channels between the outer surface of the main body and the inner wall of the primary vessel 502. The surfaces of the main body between the support members can be flat, curved or have another suitable geometry. The support members and the main body may be a singular structure or may be separate structures.

Embodiments include other types of geometric shapes for float end caps. The top end cap may be teardrop-shaped, dome-shaped, cone-shaped, or any other appropriate shape. The bottom end cap may be teardrop-shaped, dome-shaped, cone-shaped, or any other appropriate shape. In other embodiments, the main body of the float 504 can include a variety of different support structures for separating samples, supporting the tube wall, or directing the suspension fluid around the float during centrifugation. Embodiments are not intended to be limited to these examples. The main body may include a number of protrusions that provide support for the tube. In alternative embodiments, the number and pattern of protrusions can be varied. The main body may include a single continuous helical structure or ridge that spirals around the main body creating a helical channel. In other embodiments, the helical ridge can be rounded or broken or segmented to allow fluid to flow between adjacent turns of the helical ridge. In various embodiments, the helical ridge spacing and rib thickness can be independently varied. In another embodiment, the main body may include a support member extending radially from and circumferentially around the main body. In another embodiment, the support members may be tapered.

The float 504 can be composed of a variety of different materials including, but not limited to, metals; organic or inorganic materials; ferrous plastics; sintered metal; machined metal; plastic materials and combinations thereof. The primary vessel 502 may have a sidewall and a first diameter. The float 504 can be captured within the primary vessel 502 by an interference fit, such that under centrifugation, a sidewall of the tube expands to permit axial movement of the float 504. When centrifugation stops, the sidewall reduces back to the first diameter to induce the interference fit. Alternatively, the sidewall may not expand and the interference fit may not occur between the float 504 and the primary vessel 502, such that the float moves freely within the tube before, during, or after centrifugation.

The cap may be composed of a variety of different materials including, but not limited to, organic or inorganic materials; plastic materials; and combination thereof.

The end caps of the float may be manufactured as a portion of the main body, thereby being one singular structure, by machining, injection molding, additive techniques, or the like; or, the end caps may be connected to the main body by a press fit, an adhesive, a screw, any other appropriate method by which to hold at least two pieces together, or combinations thereof.

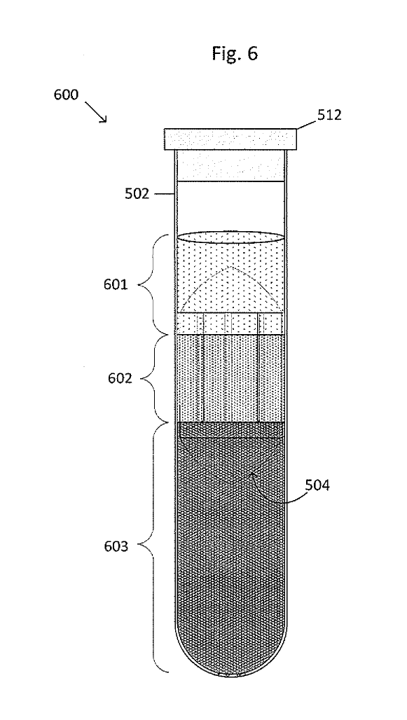

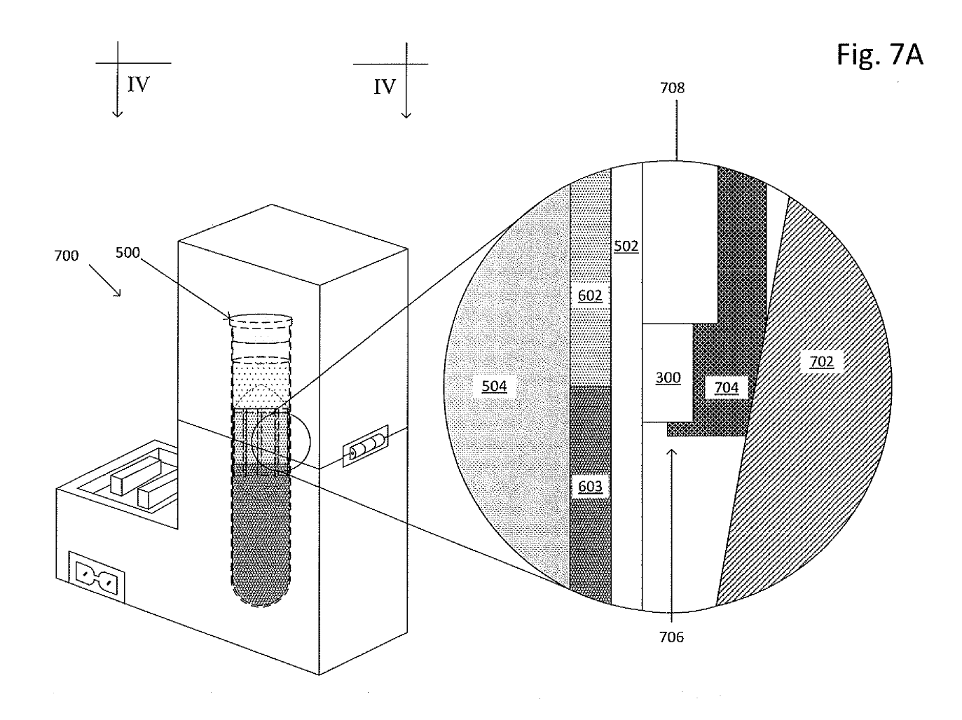

Returning to FIG. 4, in block 406, the primary vessel and the whole blood undergo density-based separation, such as by centrifugation, thereby permitting separation of the whole blood into density-based fractions along an axial position in the tube based on density. FIG. 6 shows an isometric view of the primary vessel and float system 500 having undergone density-based separation, such as by centrifugation. Suppose, for example, the whole blood includes three fractions. For convenience sake, the three fractions include plasma, Buffy coat, and red blood cells. However, when another suspension undergoes centrifugation, there may be more than, less than, or the same number of fractions, each fraction having a different density. The suspension separates into three fractions along an axial position in the tube based on density, with red blood cells 603 located on the bottom, plasma 601 located on top, and Buffy coat 602 located in between. The float 504 may have any appropriate density to settle within one of the fractions. The density of the float 504 can be selected so that the float 504 settles at the same axial position of the Buffy coat 602. The Buffy coat 602 can be trapped within an area between the float 504 and the primary vessel 402.

Delineation fluids (not shown) may also be used to cause further separation between the target material and any non-target material above and/or below the target material, for example, to further separate the Buffy coat 602 and the plasma 601 and the Buffy coat 602 and the red blood cells 603. The delineation fluid (not shown) may have a density greater than or less than the target material. For example, when it is desirous to further separate the Buffy coat 602 and the red blood cells 603, the delineation fluid may have a density greater than the Buffy coat 602 and less than the red blood cells 603. The delineation fluid (not shown) may be miscible or immiscible with the suspension fluid and inert with respect to the suspension materials. The density of the delineation fluid (not shown) may be static (e.g. remaining constant) or dynamic (e.g. changing based on outside or environmental conditions, including pressure or temperature). The delineation fluid (not shown) may also provide an area in which to seal the tube, as there is greater delineation and separation between the Buffy coat 602 and the red blood cells 603. The delineation fluid (not shown) may be used whether or not a float is used. Additionally, more than one delineation fluid may be used. Examples of suitable delineation fluids include, but are not limited to, Percoll, Ficoll, an organic solvent, a liquid wax, an oil, a gas, and combinations thereof; olive oil, mineral oil, silicone oil, chill-out liquid wax, paraffin wax, microcrystalline waxes, soy and palm waxes, candle waxes, thermoset waxes, hot melt adhesives, atactic polypropylene and polyolefin compounds, petroleum waxes, dental waxes, animal waxes, vegetable waxes, mineral waxes, petroleum waxes, and synthetic waxes, such as ethylenic polymers, chlorinated naphthalenes or hydrocarbon-type waxes; immersion oil, mineral oil, paraffin oil, silicon oil, fluorosilicone, perfluorodecalin, perfluoroperhydrophenanthrene, perfluorooctylbromide, and combinations thereof; organic solvents such as 1,4-Dioxane, acetonitrile, ethyl acetate, tert-butanol, cyclohexanone, methylene chloride, tert-Amyl alcohol, tert-Butyl methyl ether, butyl acetate, hexanol, nitrobenzene, toluene, octanol, octane, propylene carbonate, tetramethylene sulfones, and ionic liquids; perfluoroketones, such as perfluorocyclopentanone and perfluorocyclohexanone, fluorinated ketones, hydrofluoroethers, hydrofluorocarbons, perfluorocarbons, perfluoropolyethers, silicon and silicon-based liquids, such as phenylmethyl siloxane.

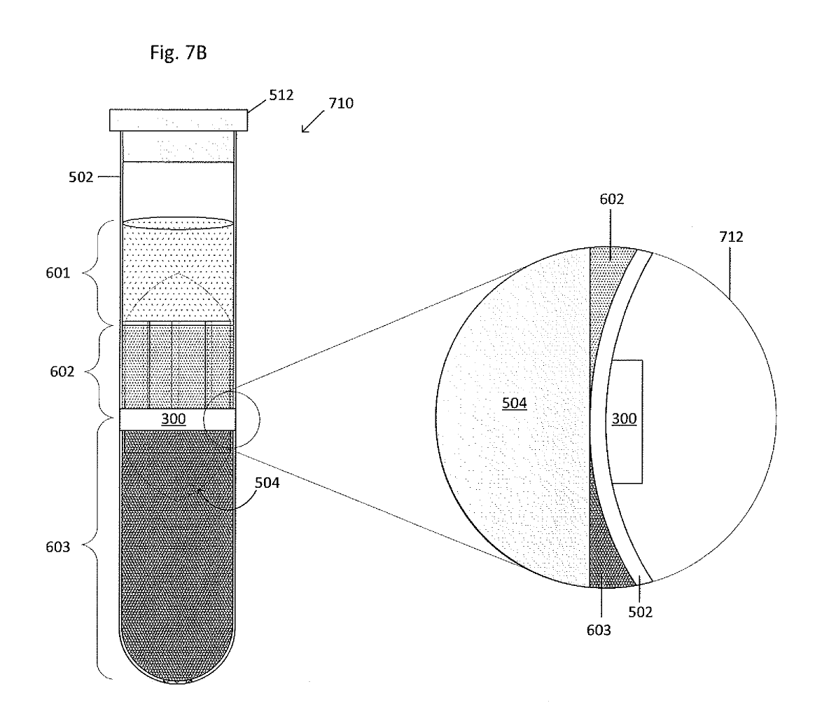

A seal may be created at least on the primary vessel, after centrifugation, when it is desirous to do so, such as between a float and the primary vessel when the float is used in the primary vessel. The seal prevents fluids from moving past the seal in any direction within the primary vessel. The seal also inhibits float movement. For example, FIG. 7A shows an isometric view of a clamp 700 with the float and primary vessel system 500. The clamp 700 is configured to circumferentially apply a force directed toward the central axis of the primary vessel 502 to the sealing ring 300 and the float and primary vessel system 500. The circumferential or radial force causes the sealing ring 300 to tighten, thereby causing the primary vessel 502 to collapse inwardly and constrict against the float 504, as shown in FIG. 7B. The clamp 700 may also include a thermal element, such as a heated wire, to soften the primary vessel 502. Alternatively, the clamp 700 may form a seal between the float 504 and primary vessel 502 without the inclusion of the sealing ring 300. Alternatively, a seal may be formed between the float 504 and the primary vessel 502 such as by ultrasonic welding; or by applying heat or a temperature gradient to deform and/or melt the primary vessel 502 to the float 504.

Magnified view 708 shows a cross-section view along the line IV-IV of the inside the clamp 700 prior to the circumferential application of the force. The sealing ring 300 is placed around the float and primary vessel system 500 after the tube and float system have undergone density-based separation, such as by centrifugation. The sealing ring 300 and float and primary vessel system 600 are then placed into the clamp 700. The clamp 700 may include a shelf 706 to support the sealing ring 300 against the primary vessel 502. Operation of the clamp 700 may be automated or may be performed manually.

When operation of the clamp 700 is automated, as seen in FIG. 7A, a motor (not shown) causes translation of either a collet (not shown), including collet fingers 704, or a pressure member 702 to cause compression of the collet fingers 704. The motor may be connected to the collet (not shown) or the pressure member 702 by a shaft, such as a cam shaft, and one or more gears. A base (not shown) engages and holds the object. When the collet (not shown) is driven by the motor, the pressure member 702 remains stationary. When the pressure member 702 is driven by the motor, the collet (not shown) remains stationary. The clamp 700 may include a release, so as to cause the pressure member 702 to slide off of the collet fingers 704, thereby removing the clamping force.

Alternatively, the clamp may be, but is not limited to, a collet clamp, an O-ring, a pipe clamp, a hose clamp, a spring clamp, a strap clamp, or a tie, such as a zip tie. The clamp may be used without a sealing ring to provide a seal between a float and a tube.

FIG. 7B shows a sealed system 710. Magnified view 710 shows the sealing ring 300 tightened around the float and primary vessel system 500. The sealing ring 300, having been placed at an interface of the Buffy coat 602 and the red blood cells 603, causes the primary vessel 502 to collapse inwardly until a seal is formed between the primary vessel 502 and the float 504. An outer wall of the sealing ring 300 may sit flush with an outer wall of the primary vessel 502; the outer wall of the sealing ring 300 may extend past the outer wall of the primary vessel 502; or, the outer wall of the primary vessel 502 may extend past the outer wall of the sealing ring 300. The sealing ring 300 remains tightened and in tension to maintain the seal. The seal prevents fluids from moving past the seal in any direction. Alternatively, the sealing ring 300 may be overtightened and then the force applied to the sealing ring 300 is removed. The sealing ring 300 may expand slightly, though still remains in tension and constricted.

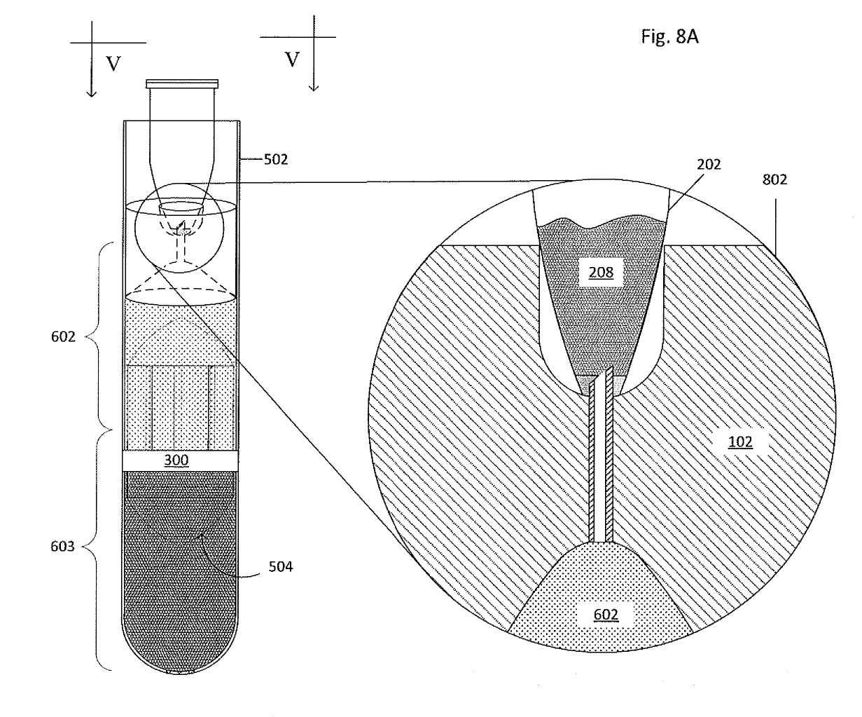

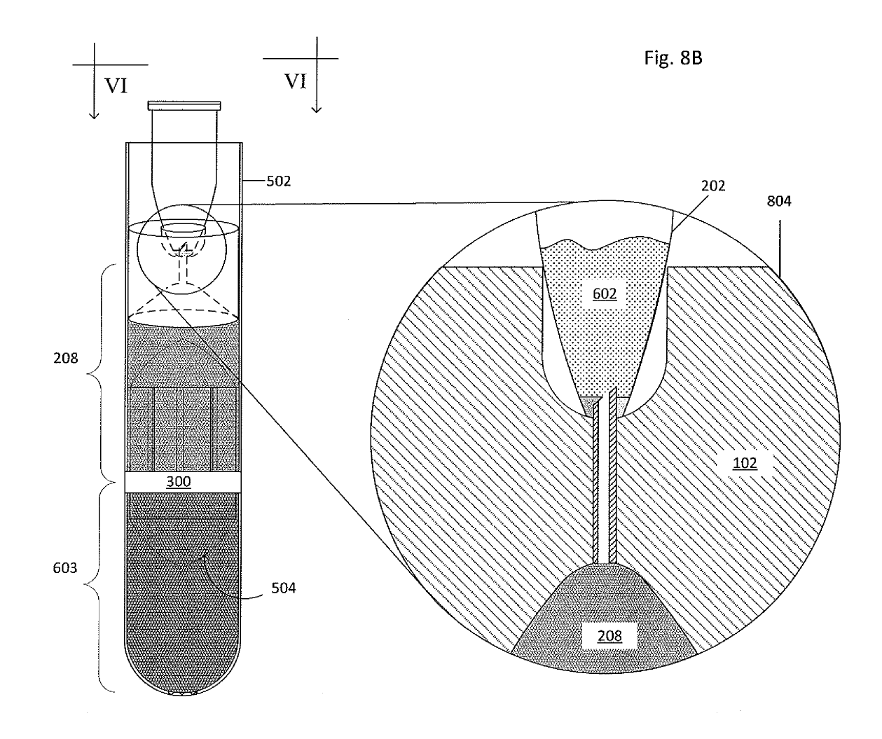

The plasma 601 shown in FIG. 7B is removed from the vessel, such as by pipetting, suctioning, pouring, or the like. Returning to FIG. 4, in block 408, a collector and processing vessel system is then added to the primary vessel. In block 410, the system is then re-centrifuged. FIG. 8A shows the collector and processing vessel system 200, as seen in FIGS. 2A-2C, inserted into the primary vessel 502. Magnified view 802, which is a cross-section view taken along the line V-V, shows the displacement fluid 208 within the processing vessel 202 and the Buffy coat 602 within the primary vessel 502. FIG. 8B shows the collector 100, the processing vessel 202, and the primary vessel 502 after having been re-centrifuged. The displacement fluid 208 from the processing vessel 202, having a density greater than the Buffy coat 602, displaces the Buffy coat 602, thereby causing the Buffy coat 602 to move upwards within the primary vessel 502 during re-centrifugation and into the funnel 108 of the collector 100, into and through the cannula 110, and into the processing vessel 202. Magnified view 804, which is a cross-section view taken along the line VI-VI, shows the exchange of the Buffy coat 602 and the displacement fluid 208. Additionally, more than one displacement fluid may be used. Alternatively, more than one processing vessel may be used, such that each processing vessel includes a different displacement fluid to displace different fractions or materials of the suspension into the respective processing vessel. Consecutive fractions may be removed from the primary vessel by displacing the respective fractions with the respective displacement fluids. For example, a first processing vessel may include a first displacement fluid to displace the plasma into the first processing vessel. A second processing vessel may include a second displacement fluid to displace the Buffy coat into the second processing vessel; the second processing vessel may also include the processing solution to effect a change on the Buffy coat.

Returning to FIG. 4, in block 412, the processing vessel 202 may then be removed from the collector 100.

After removal, the processing vessel 202 may be shaken, such as by a vortex mixer. The processing solution 210, having been added before shaking either in liquid form, in a dissolvable casing, or in a breakable casing, may then mix with the Buffy coat 602 to effect a transformation and form a Buffy coat-processing solution mixture. The Buffy coat-processing solution mixture may then be dispensed onto a substrate, such as a microscope slide.

The target material may be analyzed using any appropriate analysis method or technique, though more specifically extracellular and intracellular analysis including intracellular protein labeling; chromogenic staining; nucleic acid analysis, including, but not limited to, DNA arrays, expression arrays, protein arrays, and DNA hybridization arrays; in situ hybridization (“ISH”—a tool for analyzing DNA and/or RNA, such as gene copy number changes); polymerase chain reaction (“PCR”); reverse transcription PCR; or branched DNA (“bDNA”—a tool for analyzing DNA and/or RNA, such as mRNA expression levels) analysis. These techniques may require fixation, permeabilization, and isolation of the target material prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist1, Snail1, ZEB1, Fibronectin, Slug, Ki-67, M30, MAGEA3, phosphorylated receptor kinases, modified histones, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, enzyme-conjugated antibodies, Pap stain, Giemsa stain, or hematoxylin and eosin stain) may be used.

A solution containing a fluorescent probe may be used to label the target material, thereby providing a fluorescent signal for identification and characterization. The solution containing the fluorescent probe may be added to the suspension before the suspension is added to the vessel, after the suspension is added to the vessel but before centrifugation, or after the suspension has undergone centrifugation. The fluorescent probe includes a fluorescent molecule bound to a ligand. The target material may have a number of different types of surface markers. Each type of surface marker is a molecule, such an antigen, capable of attaching a particular ligand, such as an antibody. As a result, ligands can be used to classify the target material and determine the specific type of target materials present in the suspension by conjugating ligands that attach to particular surface markers with a particular fluorescent molecule. Examples of suitable fluorescent molecules include, but are not limited to, quantum dots; commercially available dyes, such as fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”); combinations of dyes, such as CY5PE, CY7APC, and CY7PE; and synthesized molecules, such as self-assembling nucleic acid structures. Many solutions may be used, such that each solution includes a different type of fluorescent molecule bound to a different ligand.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/We claim:

1. A collector comprising:
a primary body including a first end and an opposing second end;
a funnel located within the primary body and having a mouth at the second end that narrows to an apex located in the interior of the primary body;
a chamber having an opening at the first end that transitions to a seat located within the interior of the primary body; and
a cannula that extends from the apex of the funnel into the chamber, the cannula to allow fluids to pass between the funnel and the chamber.

2. The collector of claim 1, further comprising a ridge that protrudes radially and extends circumferentially around the primary body.

3. The collector of claim 1, the primary body further comprising a window to access at least a portion of the chamber.

4. The collector of claim 1, wherein the cannula is a tube.

5. The collector of claim 1, wherein the cannula includes a tapered end that at least partially extends in the chamber.

6. A collector comprising:
a primary body including a first end and an opposing second end, the primary body including:
a conical-shaped opening in the second end that narrows to an apex within the primary body, and
a cavity with an opening at the first end; and
a cannula that extends from the apex into the cavity, the cannula to provide an opening between the conical-shaped opening and the cavity.

7. The collector of claim 6, further comprising a ridge that protrudes radially and extends circumferentially around the primary body.

8. The collector of claim 6, the primary body further comprising a window to access at least a portion of the cavity.

9. The collector of claim 6, wherein the cannula is a tube.

10. The collector of claim 6, wherein the cannula includes a tapered end that at least partially extends in the cavity.

11. A system for retrieving a target material from a suspension stored in a primary vessel, the system comprising:
a processing vessel;
a collector having a first opening and a second opening connected by a cannula that extends partially into the second opening, the collector dimensioned to fit within an opening of the primary vessel; and
a displacement fluid to be placed in the processing vessel, wherein when the collector is placed in contact with the suspension through the opening of the primary vessel and the processing vessel is inserted in the first opening such that the cannula extends into the processing vessel, centrifugation of the primary vessel, collector, and processing vessel causes the displacement fluid to exchange places with a fraction of the suspension via the cannula.

12. The system of claim 11, the collector comprising:
a primary body including a first end and an opposing second end, the primary body including:
a conical-shaped opening in the second end that narrows to an apex within the primary body, and
a cavity with an opening at the first end; and
a cannula that extends from the apex into the cavity, the cannula to provide an opening between the conical-shaped opening and the cavity.

13. The system of claim 12, the processing vessel further comprising:
the at least one processing vessel comprising:
a first open end,
a second closed end, and
a plug in the second closed end, the plug to be re-sealable such that the plug can be repeatedly punctured with the cannula,

14. The system of claim 12, the collector further comprising a ridge extending circumferentially around the primary body.

15. The system of claim 12, the collector further comprising at least one window in the primary body to access at least a portion of the cavity.

16. The system of claim 11, the at least one displacement fluid to have a density greater than the target material.

17. The system of claim 11, the at least one displacement fluid to have a density less than the target material.

18. The system of claim 13, the at least one processing vessel further comprising a flexible cap to close the first open end.

19. The system of claim 11, further comprising:
a primary vessel having an open end to receive the suspension and the collector;
a float to be inserted within the primary vessel; and,
a sealing ring to tighten around the primary vessel to collapse the primary vessel inwardly until a seal is formed between the primary vessel and the float, the sealing ring to create a force directed toward a central axis of the primary vessel to cause the primary vessel to collapse inwardly.

20. The system of claim 14, further comprising:
a primary vessel having an open end to receive the suspension and the collector; and
a lock ring to apply to the outside of the primary vessel at the location of the ridge to inhibit movement of the collector relative to the primary vessel when the collector is inserted into the primary vessel.
